(19) United States
(12) Patent Application Publication
(10) Pub. No.: US 2013/0135229 A1
(43) Pub. Date: May 30, 2013

(54) TOUCH PANEL AND TOUCH DISPLAY PANEL USING THE SAME

(71) Applicant: HengHao Technology Co. LTD, Taoyuan County (TW)

(72) Inventors: Ming-Hsi Wang, New Taipei City (TW); Yu-Jen Chen, Pingtung County (TW)

(73) Assignee: HENGHAO TECHNOLOGY CO. LTD, Taoyuan County (TW)

(21) Appl. No.: 13/669,249

(22) Filed: Nov. 5, 2012

(30) Foreign Application Priority Data
Nov. 25, 2011 (TW) 100222409

(51) Int. Cl. G06F 3/041

(52) U.S. Cl. 345/173

(57) ABSTRACT

A touch panel and a touch display panel using the same are provided. The touch panel includes a substrate, a sensing structure layer and a conductive pad layer. The substrate has a sensing surface and an outer lateral surface. The outer lateral surface of the substrate and the sensing surface define a border. The sensing structure layer is formed on sensing surface of the substrate and extends to the border. The conductive pad layer is formed on the outer lateral surface of the substrate and extends to the border for electrically connecting to the sensing structure layer.

### CROSS-REFERENCE TO RELATED APPLICATIONS

The entire contents of Taiwan Patent Application No. 100222409, filed on Nov. 25, 2011, from which this application claims priority, are incorporated herein by reference.

### BACKGROUND OF THE INVENTION

1. Field of the Invention

The invention relates in general to a touch panel and a touch display panel using the same, and more particularly to a touch panel capable with the sensing structure and the signal transmission lines being respectively formed on the different elements and a touch display panel using the same.

2. Description of Related Art

The conventional touch panel includes a substrate, a sensing layer and a plurality of signal transmission lines, wherein the sensing layer is formed on the substrate, and the signal transmission lines are connected to the sensing layer and formed on the border of the substrate. The signal transmission lines may transmit a sensing signal from the sensing layer to a circuit.

However, as the substrate needs to provide a marginal part for the signal transmission lines, it will be difficult to effectively reduce the size of substrate.

### SUMMARY OF THE INVENTION

The invention is directed to a touch panel and a touch display panel using the same capable of reducing the size of the touch panel.

According to an embodiment of the present invention, a touch panel is provided. The touch panel includes a substrate, a sensing structure layer and a conductive pad layer. The substrate has a sensing surface and an outer lateral surface. The outer lateral surface of the substrate and the sensing surface define a border. The sensing structure layer is formed on sensing surface of the substrate and extends to the border. The conductive pad layer is formed on the outer lateral surface of the substrate and extends to the border for electrically connecting to the sensing structure layer.

According to another embodiment of the present invention, a touch display panel is provided. The touch display panel includes a touch panel, a display panel and a frame. The touch panel includes a substrate, a sensing structure layer and a conductive pad layer. The substrate has a sensing surface and an outer lateral surface. The outer lateral surface of the substrate and the sensing surface define a border. The sensing structure layer is formed on sensing surface of the substrate and extends to the border. The conductive pad layer is formed on the outer lateral surface of the substrate and extends to the border for electrically connecting to the sensing structure layer. The frame includes a frame body and a signal line layer. The frame body supports the touch panel and the display panel and has an inner side surface. The signal line layer is formed on the inner side surface of the frame body and is connected to the conductive pad layer.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 shows a touch panel according to an embodiment of the invention;

FIG. 2A shows a top view of a touch display panel according to an embodiment of the invention;

FIG. 2B shows a cross-sectional view along the direction 2B-2B′ of FIG. 2A;

FIG. 3 shows the frame in FIG. 2A;

FIG. 4 shows a schematic drawing of the touch panel in FIG. 2A configured into the frame in FIG. 3;

FIG. 5 shows a touch panel according to another embodiment of the invention;

FIG. 6 shows a frame according to another embodiment of the invention;

FIG. 7 shows a schematic drawing of the touch panel in FIG. 5 being configured into the frame in FIG. 6;

FIG. 8 shows a touch panel according to another embodiment of the invention;

FIG. 9 shows a frame according to another embodiment of the invention; and

FIG. 10 shows a schematic drawing of the touch panel in FIG. 8 being configured into the frame in FIG. 9.

### DETAILED DESCRIPTION OF THE INVENTION

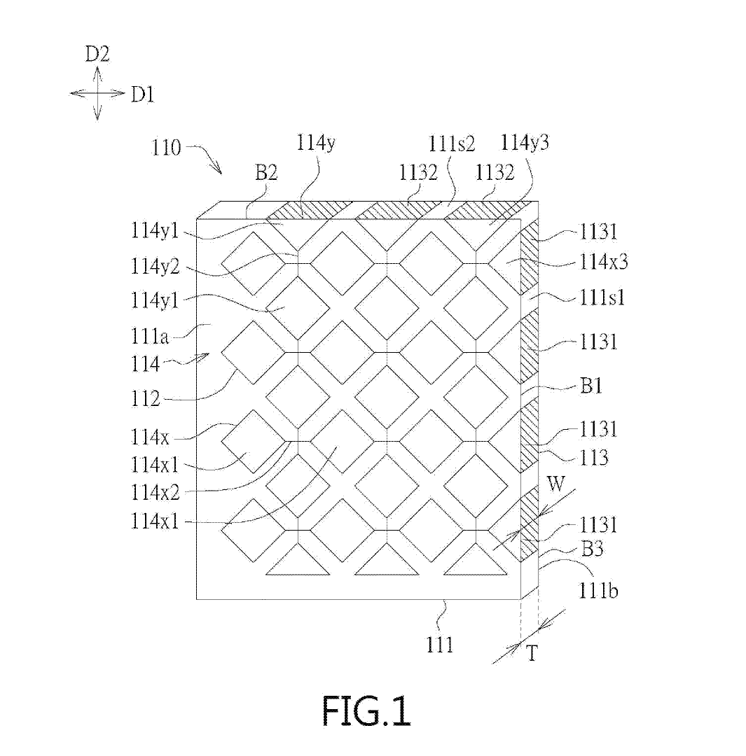

Referring to FIG. 1, a touch panel according to an embodiment of the invention is shown. In the embodiment, touch panel 110 is a capacitive touch panel.

The touch panel 110 includes a substrate 111, a sensing structure layer 112 and a conductive pad layer 113.

The substrate 111 has a sensing surface 111a and an outer lateral surface. In the present embodiment, the outer lateral surface include a first outer lateral surface 111s1 and a second outer lateral surface 111s2, and the first outer lateral surface 111s1 and the second outer lateral surface 111s2, for example, are two outer lateral surfaces, which are connected to each other. The first outer lateral surface 111s1 and the second outer lateral surface 111s2 define a border of the substrate 111, wherein the first outer lateral surface 111s1 and the sensing surface 111a are connected to a border B1, and the second outer lateral surface 111s2 and the sensing surface 111a are connected to another border B2.

The substrate 111 is a transparent the substrate, made from a high transmittance insulating material, such as glass, polycarbonate (PC), polythylene terephthalate (PET), polymethylmethacrylate (PMMA) or cyclic olefin copolymer.

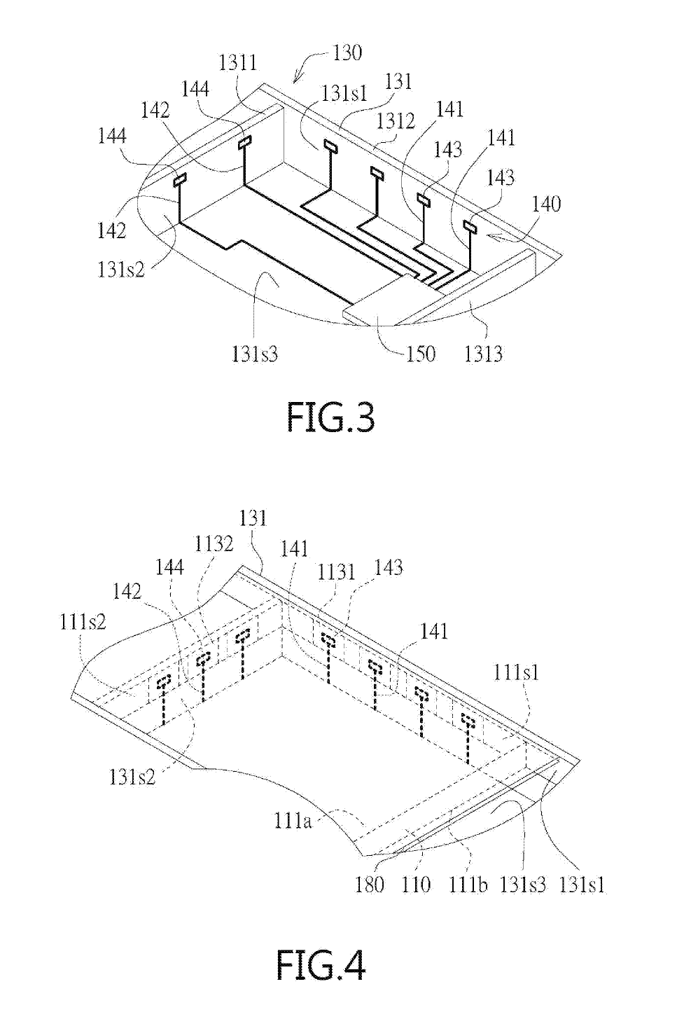

As indicated in FIG. 1, the sensing structure layer 112 is formed on the sensing surface 111a of the substrate 111 and extended to the borders B1 and B2. The sensing structure layer 112 includes a plurality of sensing structures 114. The sensing structures 114 can transmit the sensing signal to the printed circuit board 150 (as the printed circuit board 150 shown in FIG. 3), and the printed circuit board 150 may calculate the coordinate of the touched position according to the sensing signal.

In the present embodiment, the sensing structure 114 includes a plurality of the first sensor rows 114x and a plurality of second sensor rows 114y.

As indicated in FIG. 1, the first sensor rows 114x are arranged in sequence and formed on the substrate 111. The first sensor rows 114x include a plurality of the first sensing units 114x1 and a plurality of the first bridge wires 114x2. The first sensing units 114x1 are arranged along a first direction D1 on the substrate 111, wherein the first direction D1 is such as X-axis direction, and two adjacent first sensing units 114x1 are connected to each other by a first bridge wire 114x2. The first sensor rows 114x may se the area touched with a finger or a stylus pen, so as to transmit a corresponding sing signal to the printed circuit board 150.

As indicated in FIG. 1, the first sensing units 114x1 include a plurality of border sensing units 114x3, wherein the border sensing units 114x3 are close to the border B1, and the edge of the border sensing units 114x3 is on the border B1

As indicated in FIG. 1, the second sensor rows 114y are arranged in sequence and formed on the substrate 111. The second sensor rows 114y include a plurality of second sensing units 114y1 and a plurality of the second bridge wires 114y2. The second sensing units 114y1 are arranged along a first direction D2 on the substrate 111, wherein the first direction D2 is such as Y-axis direction, and two adjacent second sensing units 114y1 are connected to each other by a second bridge wire 114y2. The second sensor rows 114y may sense the area touched with a finger or a stylus pen. Furthermore, the second bridge wires 114y2 and the corresponding first bridge wires 114x2 are electrically isolated by an isolating block (not shown) to prevent the second sensor rows 114y from being electrically connected to the first sensor rows 114x.

As indicated in FIG. 1, the second sensing units 114y1 include a plurality of the border sensing units 114y3, wherein the border sensing units 114y3 are dose to the border B2, and the edge of the border sensing units 114y3 is on the border B2.

Furthermore, the first sensing units 114x1 and the second sensing units 114y1 are made from such as a transparent conductive oxide (TCO) or a transparent organic conductive material. The transparent conductive material is such as indium tin oxide (ITO) or indium zinc oxide (IZO), and the transparent organic conductive material is such as Poly(3, 4-ethylenedioxythiophene) poly(styrenesulfonate) (PEDOT). The first bridge wires 114x2 and the second bridge wires 114y2 are made from such as a metal or a transparent conductive material, and the metal may be selected from a group consisting of titanium, aluminum, molybdenum, copper, silver and a combination thereof.

As indicated in FIG. 1, the conductive pad layer 113 is formed on an outer lateral surface of the substrate 111 and extended to the borders B1 and B2, so as to connect the sensing structure layer 112. The conductive pad layer 113 includes a plurality of the first lateral pads 1131 and a plurality of the second lateral pads 1132. The first lateral pads 1131 are connected to the first sensor rows 114x, such as the corresponding border sensing units 114x3, and the second lateral pads 1132 are connected to the second sensor rows 114y, such as the corresponding border sensing units 114y3.

In the present embodiment, the first lateral pads 1131 extend from the border B1 to a border B3 of an opposite surface 111b of the substrate 111, wherein the opposite surface 111b and the sensing surface 111a are two opposite surfaces of the first substrate 111. In other words, the width W of the first lateral pad 1131 is substantially equal to the thickness T of the substrate 111. However, the present embodiment is not limited by this application. In another embodiment, the first lateral pad 1131 cannot extend to the border B3 of the opposite surface 111b as described later in this application.

The first lateral pads 1131 are made from such as a conductive material, such as copper or other metal materials. The first lateral pad 1131 may be formed on the first outer lateral surface 111s1 of the substrate 111 by the screen printing or the transfer printing. In another embodiment, the first lateral pads 1131 may be formed by chemical vapor deposition, electroless plating, electrolytic plating, printing, spin coating, spray coating, sputtering, vacuum deposition, or other relative methods, and the patterning techniques, such as photolithography or chemical etching, may also be selectively used in the process for forming the first lateral pads 1131. The material and structure of the second lateral pad 1132 are similar to those of the first lateral pad 1131, and the similarities are not repeated here.

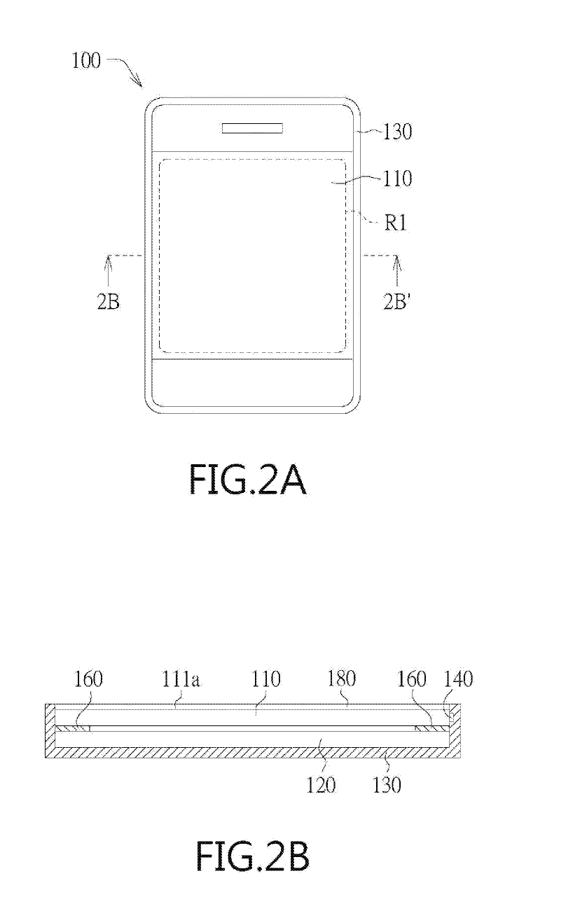

Referring to FIG. 1, FIG. 2A and FIG. 2B, FIG. 2A shows a top view of a touch display panel according to an embodiment of the invention; and FIG. 2B shows a cross-sectional view along the direction 2B-2B′ of FIG. 2A.

The touch panel 110 may be electrically connected to the signal line layer 140 (FIG. 2B) of the frame 130 (FIG. 2B) by the first lateral pads 1131 and the second lateral pads 1132. In this case, the touch panel 110 can neglect the signal line layer so that the size of the touch panel 110 may be reduced. Furthermore, as the touch panel 110 can be electrically connected to the signal line layer 140 of the frame 130 by the first lateral pads 1131 and the second lateral pads 1132, so as to connect the printed circuit board 150. Therefore, the touch panel 110 may neglect the flexible printed circuit board.

The touch display panel 100 can be used in the handheld electronic devices, notebook computers and tablet PCs. The present embodiment is illustrated by use of the mobile phone.

As indicated in FIG. 2A, the touch display panel 100 includes the touch panel 110, the display panel 120 and the frame 130, which are mentioned above.

As indicated in FIG. 2A, the area R1 of the touch display panel 100 is substantially equal to the area of the sensing surface 111a of the touch panel 110. As the signal layer cannot be formed on the edge of the sensing surface 111a of the touch panel 110, the touch display panel 100 may neglect the marginal light shading layer (such as black matrix) so that the touch display panel 100 may have a frameless design.

As indicated in FIG. 2B, the display panel 120 may be realized by any types of display panels such as an electrophoretic display, a cholesterol LCD, a liquid crystal, a bi-stable display, a multi-stable display, an organic light-emitting diode (OLED) display or a light-emitting diode (LED) display.

The touch display panel 100 further includes an adhesive part 160, such as a double-side adhesive (DSA), for fixing the display panel 120 and the touch panel 110.

As indicated in FIG. 2B, the touch display panel 100 further includes cover lens 180. The cover lens 180 cover the sensing surface 111a of the touch panel 110 to protect the sensing structure layer 112. In addition, the material of the cover lens 180 is such as glass or plastics.

Referring to FIG. 3, FIG. 3 shows the frame in FIG. 2A. The frame 130 includes a frame body 131 and a signal line layer 140. The frame body 131 may accommodate the touch panel 110, the display panel 120 and the cover lens 180.

In the present embodiment, the frame body 131 includes the first side surface 1311 and the second side surface 1312. When the touch panel 110 is configured into frame body 131, the first side surface 1311 is corresponding to the second outer lateral surface 111s2, and the second side surface 1312 is corresponding to the first outer lateral surface 111s1

As indicated in FIG. 3, the frame body 131 has an inner side surface and an inner bottom surface 131s3, wherein the inner side surface includes the first inner side surface 131s1 and the second inner side surface 131s2. The touch display panel 100 further includes a printed circuit board 150, which is configured on the inner bottom surface 131s3 of the frame body 131.

As indicated in FIG. 3, the signal line layer 140 is formed on the first inner side surface 131s1, the second inner side surface 131s2 and the inner bottom surface 131s3 of the frame body 131, and the signal line layer 140 may be connected to the conductive pad layer 113 of the touch panel 110 (after the touch panel 110 is configured into the frame 130). The signal line layer 140 extends from the first inner side surface 131s1 and the second inner side surface 131s2 to the inner bottom surface 131s3, being electrically connected to the printed circuit board 150.

As indicated in FIG. 3 and FIG. 4, FIG. 4 a schematic drawing of the touch panel in FIG. 2A configured into the frame in FIG. 3. In order to clearly show the structure, the side surface 1313 of FIG. 3 is not shown in FIG. 4.

As indicated in FIG. 4, when the touch panel 110 is configured into the frame 130, the opposite surface 111b of touch panel 110 is opposite to inner bottom surface 131s3 of the frame body 131, and the first outer lateral surface 111s1 of the touch panel 110 is opposite to the first inner side surface 131s1 of the frame body 131, and the second outer lateral surface 111s2 is opposite to the second inner side surface 131s2 of the frame body 131.

In the present embodiment, the sensing surface 111a of the touch panel 110 is configured into frame 130 in an outward direction, so the cover lens 180 may protect the sensing structure layer 112 formed on the sensing surface 111a (not shown in FIG. 4). In another embodiment, the touch panel 110 may be configured into the frame 130 in a forward direction (that is, the sensing structure layer 112 is facing the internal part of the frame 130). In this case, the protective film 170 (FIG. 10) may be used to replace the cover lens 180. In the present embodiment, the size of the cover lens 180 may be greater than that of the touch panel 110.

As indicated in FIG. 3 and FIG. 4, the signal line layer 140 of the frame 130 includes a plurality of the signal lines, and each signal line is electrically connected to the first lateral pad 1131 or the second lateral pad 1132, which is corresponding to the conductive pad layer 113 of the touch panel 110. Furthermore, the signal lines include a plurality of the first signal lines 141 and a plurality of the second signal lines 142. The first signal line 141 is connected to a corresponding first lateral pad 1131 (FIG. 4), in order to transmit the sensing signal from the first sensor rows 114x to the printed circuit board 150. The connection and the structure of the second signal lines 142 are similar to those of the first signal lines 142, and the similarities are not repeated here. In addition, the material of the first signal line 141 and the second signal line 142 is such as a metal.

As indicated in FIG. 3, in the present embodiment, the first signal lines 141 and/or the second signal lines 142 extend to the inner bottom surface 111s3 along the direction which is substantially perpendicular to the inner bottom surface 111s3, and the present invention is not limited to such applications. In another embodiment, the signal lines may extend to the inner bottom surface 111s3 along other directions as described later in this application.

As indicated in FIG. 3 and FIG. 4, the signal line layer 140 further includes a plurality of the first signal pads 143 and a plurality of the second signal pads 144. When the touch panel 110 is configured into the frame 130, the first signal lines 141 are connected to the corresponding first signal pads 143, and the second signal lines 142 are connected to the corresponding second signal pads 144. The first signal pads 143 provide a large area such that the first signal pads 143 may be electrically connected to the corresponding first lateral pads 1131 with the large area, so as to improve the quality of the electrical connection. The connection and the structure of the second signal pads 144 are similar to those of the first signal pads 143, and the similarities are not repeated here.

The signal line layer 140 is made from such as a conductive material, such as copper or other metal materials. The signal line layer 140 may be formed on the frame 130 by the screen printing or the transfer printing. In another embodiment, the signal line layer 140 may be formed by chemical vapor deposition, electroless plating, electrolytic plating, printing, spin coating, spray coating, sputtering, vacuum deposition, or other relative methods, and the patterning techniques, such as photolithography or chemical etching, may also be selectively used in the process for forming the first lateral pads 1131.

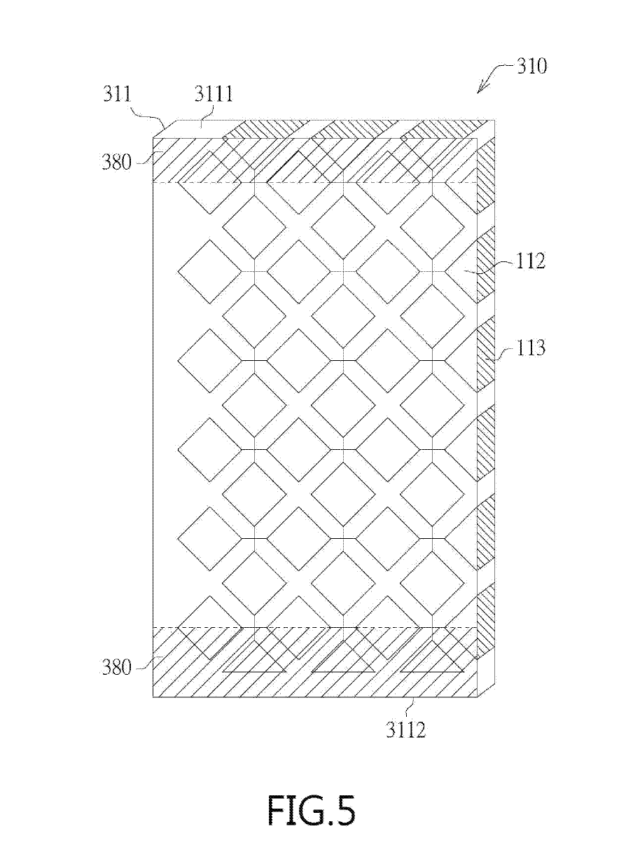

As indicated in FIG. 5, FIG. 5 shows a touch panel according to another embodiment of the invention. The touch panel 310 includes a substrate 311, a sensing structure layer 112 and a conductive pad layer 113. Compared to the substrate 111, the substrate 311 in the present embodiment includes the first side 3111 and the second side 3112, which are opposite to each other. The sensing structure layer 112 and the conductive pad layer 113 are formed on first side 3111 and the second side 3112, and the structure and the forming method are similar to those in the embodiments mentioned above, so the similarities are not repeated here.

The touch panel 310 further includes a light shading layer 380, which is formed on the first side 3111 and the second side 3112. The light shading layer 380 covers the sing structure layer 112 formed on the first side 3111 and the second side 3112, so as to prevent the sensing structure layer 112 from being exposed from the appearance, wherein the light shading layer 380 is such as a black matrix (BM).

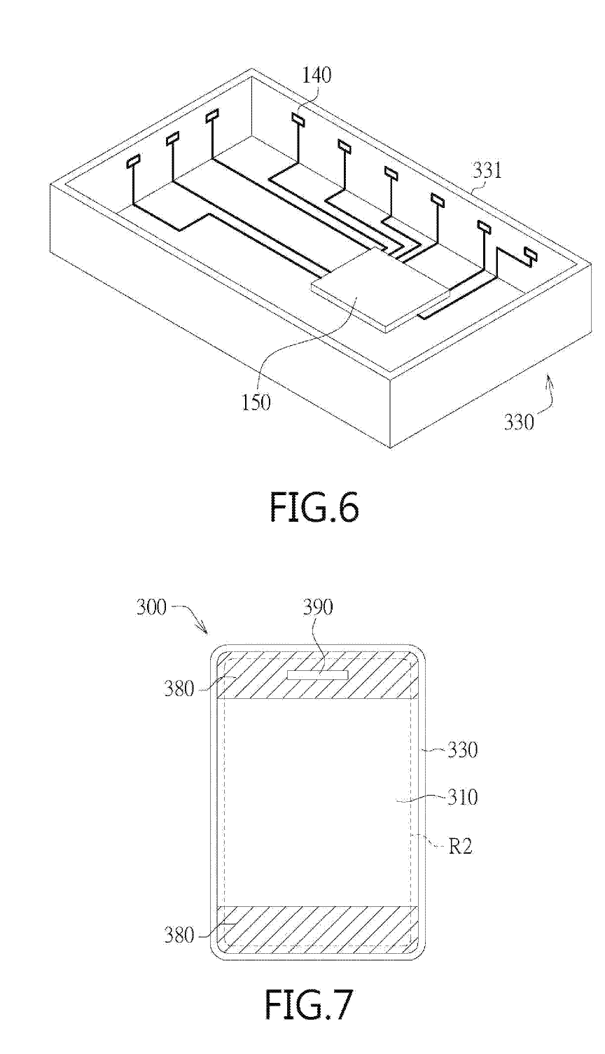

Referring to FIG. 6, FIG. 6 shows a frame according to another embodiment of the invention. The frame 330 includes a frame body 331 and a signal line layer 140. The signal line layer 140 is formed on inner surface of the frame body 331. Compared to the frame 130 in FIG. 3, the frame 330 in the present embodiment may neglect the first side surface 1311 the second side surface 1312 and the side surface 1313.

Referring to FIG. 7, FIG. 7 shows a schematic drawing of the touch panel in FIG. 5 being configured into the frame in FIG. 6. The touch display panel 300 includes the touch panel 310, the display panel 120 (not shown in FIG. 7) and the frame 330, are mentioned above. The range of the touch panel 310 is corresponding to the area R2 of the touch display panel 300. In the present embodiment, the size of the frame 330 is substantially equal to the size of the touch panel 310.

The connection relations of the conductive pad layer 113 of the touch panel 310 and the signal line layer 140 of the frame 330 are similar to those of the conductive pad layer 113 of the touch panel 110 and the signal line layer 140 of the frame 130, and the similarities are not repeated here.

In addition, the touch display panel 300 further includes at least one optical device, such as a digital camera 390, and the optical device may configured in the frame 330 in correspondence to the area of the light shading layer 380. With the use of the light shading layer 380, it may prevent at least one part of the digital camera 390 from being exposed from the appearance.

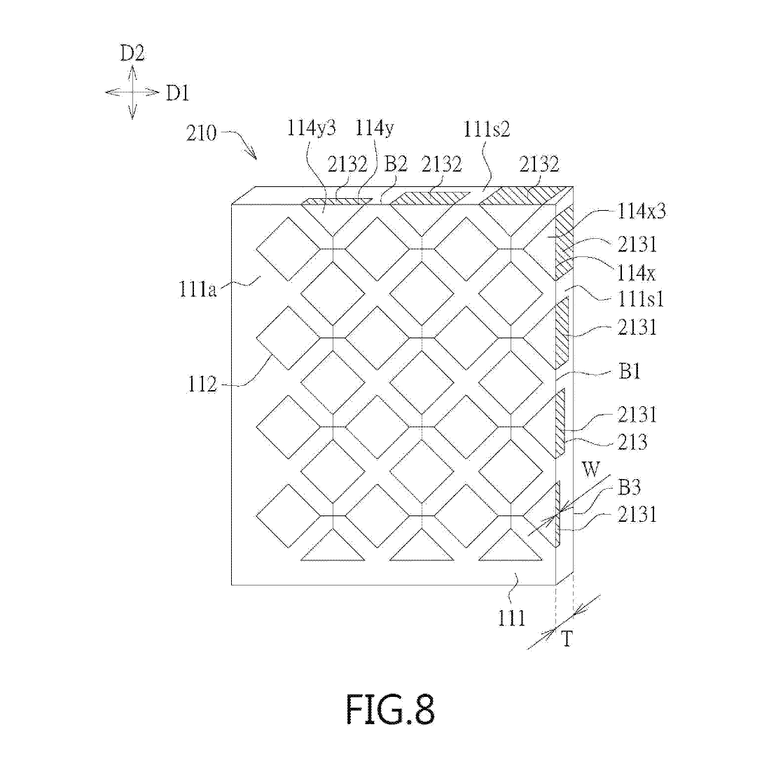

Referring to FIG. 8, FIG. 8 shows a touch panel according to another embodiment of the invention. The touch panel 110 includes a substrate 111, a sensing structure layer 112 and a conductive pad layer 213.

The conductive pad layer 213 includes a plurality of first lateral pads 2131 and a plurality of second lateral pads 2132. The first lateral pads 2131 are connected to the first sensor rows 114x, such as being connected to the corresponding border sensing units 114x3. The second lateral pads 2132 are connected to the second sensor rows 114y, such as being connected to the corresponding border sensing units 114y3.

In the present embodiment, not all of the first lateral pads 2131 extend to the border B3 of the opposite surface 111b, and some of the first lateral pads 2131 may not extend to the opposite surface 111b. The width of the first lateral pads 2131, which are not extended to the opposite surface 111b, is shorter than the thickness T of the substrate 111. The structure of the second lateral pad 2132 is similar to that of the first lateral pad 1131, and the similarities are not repeated here.

In the present embodiment, the widths W of the first lateral pads 2131 and the widths W of the second lateral pads 2132 become greater or shorter along the second direction D2. In another embodiment, the widths W of the first lateral pad 2131 and the widths W of the second lateral pads 2132 are not limited by this application, and may be changed according to the actual requirement or design.

In the present embodiment, there is no limitation to the widths of the first lateral pads 2131 and the method for extending the first lateral pads 2131, as long as the first lateral pads 2131 won't cause short circuit with the adjacent first signal lines 241, when the first lateral pads 2131 of the touch panel 210 are electrically connected to the corresponding first signal lines 241 of the frame 230 (as shown in FIG. 10). The limitation of the second lateral pads 2132 of the touch panel 210 is similar to that of the first lateral pads 2131.

Furthermore, the conductive pad layer in FIG. 1 and FIG. 5 may adopt the design of the conductive pad layer 213 in the present embodiment.

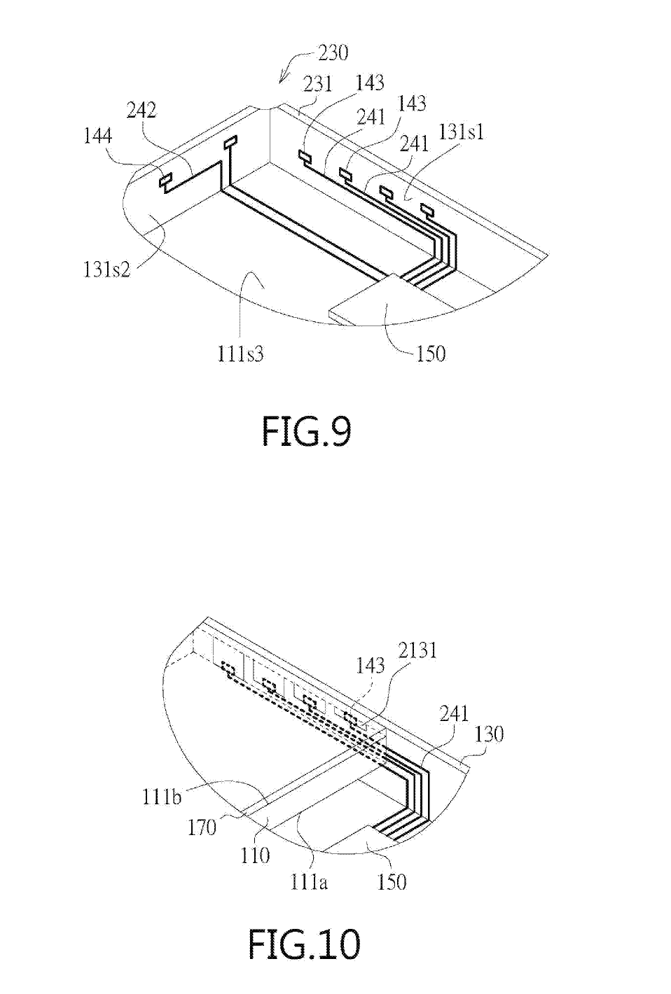

Referring to FIG. 9, FIG. 9 shows a frame according to another embodiment of the invention. The frame 230 includes a frame body 131 and a signal line layer 240. The frame body 131 may accommodate the touch panel 110, the display panel 120 and the protective film 170.

The signal line layer 240 includes a plurality of signal lines. Each signal line is electrically connected to the first lateral pad 2131 or the second lateral pad 2132 of the conductive pad layer 213, and the further explanation is provided below.

Referring to FIG. 10, FIG. 10 shows a schematic drawing of the touch panel in FIG. 8 being configured into the frame in FIG. 9.

The signal line layer 240 includes a plurality of the first signal lines 241 and a plurality of the second signal fines 242. Each first signal line 241 is connected to the corresponding first lateral pad 2131 of the conductive pad layer 213, in order to transmit the sensing signal from the first sensor rows 114x to the printed circuit board 150.

When the touch panel 210 is configured into the frame 230, each first signal pad 143 contacts the corresponding first lateral pad 2131. Although not shown in the figure, each second signal pad 144 contacts the corresponding second lateral pad 2132.

As indicated in FIG. 9 and FIG. 10, the first signal lines 241 and/or the second signal lines 242 may extend to the positions corresponding to the printed circuit board 150 along the direction which is substantially parallel to the inner bottom surface 111s3, and then extend to the inner bottom surface 111s3 along the direction which is substantially perpendicular to the inner bottom surface 111s3, and afterwards extend on the inner bottom surface 111s3 to connect the printed circuit board 150.

In conclusion, the first signal lines 241 and/or the second signal lines 242 formed on the first inner side surface 131s1 and the second inner side surface 131s2 may extend along a perpendicular direction and/or a parallel direction. When the first signal lines 241 and/or the second signal lines 242 extend to the inner bottom surface 131s3, and then may also extend along a perpendicular direction and/or a parallel direction. There is no limitation to the widths of the first signal line 241 and the method for extending the first signal line 241, as long as the first signal line 241 won't cause a short circuit with other adjacent first lateral pad 2131, when the first signal lines 241 and the corresponding first lateral pads 2131 are electrically connected (as shown in FIG. 10). The limitation of the second signal line 242 is similar to that of the first lateral pads 241.

Furthermore, the designs of the first signal lines 241 and the first lateral pads 2131 may be changed to complement each other. The designs of the second signal lines 242 and the second lateral pads 2132 are similar to those of the first signal lines 241 and the first lateral pads 2131, and the similarities are not repeated here.

In addition, the protective film 170 formed on the touch panel 110 may protect the touch panel 110. The material of the protective film 170 may include silicon oxide, magnesium fluoride, aluminum oxide or yttrium oxide.

In the present embodiment, the sensing surface 111a of the touch panel 110 is configured into the frame 130 in a forward direction, so the protective film 170 may be used to replace the cover lens. In another embodiment, the touch panel 110 may be configured into the frame 130 in an outward direction (that is, the sensing structure layer 112 is facing the external part of the frame 130). In this case, the cover lens 180 (as shown in FIG. 2B) may be configured on the sensing surface 111a, so as to protect the sensing structure layer 112 formed on the sensing surface 111a (not shown in FIG. 10).

The touch panel and the touch display panel using the same, disclosed in the above embodiments, are capable of reducing the size of the touch panel.

While the invention has been described by way of example and in terms of the preferred embodiment (s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A touch panel, comprising:
a substrate having a sensing surface and an outer lateral surface, wherein the outer lateral surface and the sensing surface define a border;
a sensing structure layer formed on the sensing surface of the substrate and extending to the border; and
a conductive pad layer formed on the outer lateral surface of the substrate and extending to the border for connecting the sensing structure layer.

2. The touch panel according to claim 1, wherein the sensing structure layer comprises a plurality of sensing structures, and the conductive pad layer comprises a plurality of pads, and each pad is connected to a corresponding sensing structure.

3. The touch panel according to claim 2, wherein the sensing structures comprise:
a plurality of first sensor rows, each being arranged along a first direction and comprising:
a plurality of first sensing units; and
a plurality of first bridge wires, two adjacent first sensing units being connected by a corresponding first bridge wire; and
a plurality of second sensor rows, each being arranged along a second direction and comprising:
a plurality of second sensing units; and
a plurality of second bridge wires, two adjacent second sensing units being connected by a corresponding second bridge wire.

4. The touch panel according to claim 3, wherein the edge of the first sensing units, which is close to the border, is substantially corresponding to the border, and the edge of the second sensing units, which is close to the border, is substantially corresponding to the border.

5. The touch panel according to claim 3, wherein the outer lateral surface of the substrate comprises a first outer lateral surface and a second outer lateral surface, and the pads comprise a plurality of first lateral pads and a plurality of second lateral pads, and wherein the first lateral pads are formed on the first outer lateral surface for connecting the first sensor rows, and the second lateral pads are formed on the second outer lateral surface for connecting the second sensor rows.

6. A touch display panel, comprising:
a touch panel, comprising:
a substrate having a sensing surface and an outer lateral surface, wherein the outer lateral surface and the sensing surface define a border;
a sensing structure layer formed on the sensing surface of the substrate and extending to the border; and
a conductive pad layer formed on the outer lateral surface of the substrate and extending to the border for connecting the sensing structure layer;
a display panel; and
a frame, comprising:
a frame body, accommodating the touch panel and the display panel and having an inner side surface; and
a signal line layer, formed on the inner side surface of the frame body and connected to the conductive pad layer.

7. The touch display panel according to claim 6, wherein the frame body has an inner bottom surface, the touch display panel further comprising:
a printed circuit board, configured on the inner bottom surface of the frame body;
wherein the signal line layer extends from the inner side surface to the inner bottom surface, extending on the inner bottom surface to connect with the printed circuit board.

8. The touch display panel according to claim 6, wherein the sensing structure layer comprises a plurality of sensing structures, and the conductive pad layer comprises a plurality of pads, each pad connected to a corresponding sensing structure.

9. The touch display panel according to claim 8, wherein the sensing structure comprise:
a plurality of first sensor rows, each being arranged along a first direction and comprising:
a plurality of first sensing units; and
a plurality of first bridge wires, two adjacent first sensing units being connected by a corresponding first bridge wire; and
a plurality of second sensor rows, each being arranged along a second direction and comprising:
a plurality of second sensing units; and
a plurality of second bridge wires, two adjacent second sensing units being connected by a corresponding second bridge wire.

10. The touch display panel according to claim 9, wherein the edge of the first sensing units, which is dose to the border, is substantially corresponding to the border, and the edge of the second sensing units, which is close to the border, is substantially corresponding to the border.

11. The touch display panel according to claim 9, wherein the outer lateral surface of the substrate comprises a first outer lateral surface and a second outer lateral surface, and the pads comprise plurality of first lateral pads and a plurality of second lateral pads, and wherein the first lateral pads are formed the first outer lateral surface for connecting the first sensor rows, and the second lateral pads are formed on the second outer lateral surface for connecting the second sensor rows.

12. The touch display panel according to claim 11, wherein the inner side surface of the frame body comprises a first inner side surface and a second inner side surface, and wherein the first outer lateral surface of the touch panel is opposite to the first inner side surface of the frame body, and the second outer lateral surface of the touch panel is opposite to the second inner side surface of the frame body.
